(19) United States
(12) Patent Application Publication
(10) Pub. No.: US 2026/0228764 A1
(43) Pub. Date: Aug. 6, 2026

(54) HIERARCHICAL DATA FORECASTING USING PROCESSOR-BASED BAYESIAN MODELS AND DEEP LEARNING

(71) Applicant: Dell Products L.P., Round Rock, TX (US)

(72) Inventors: Ali Mehrnezhad, Liberty Hill, TX (US); Punyamantula Krushi, Bangalore (IN); Angel Hernandez, Kansas City, MO (US); Siamak Saliminejad, Austin, TX (US); Prateek Srivastava, Cedar Park, TX (US)

(21) Appl. No.: 19/046,997

(22) Filed: Feb. 6, 2025

(51) Int. Cl. G06Q 30/0202

(52) U.S. Cl. CPC G06Q 30/0202

(57) ABSTRACT

Techniques are provided for hierarchical data forecasting using processor-based Bayesian models and deep learning. One method comprises obtaining data characterizing a performance of hierarchical items, wherein the hierarchical items comprise one or more item families in an item family hierarchical level and multiple items in an item hierarchical level; applying at least portions of the obtained data to a processor-based Bayesian-based model to obtain output data characterizing an item family forecast for at least one item family and a first item-level forecast for one or more of the items; applying at least portions of the obtained output data to a processor-based deep learning model to obtain data characterizing a second item-level forecast for one or more of the items; and initiating one or more processing steps based at least in part on the at least one second item-level forecast.

### BACKGROUND

As the value and use of information continues to increase, individuals and businesses seek additional ways to process and/or store information. Information processing systems may be used to process, compile, store and/or communicate various types of information, including with artificial intelligence (AI) and/or machine learning (ML).

### SUMMARY

Illustrative embodiments of the disclosure provide techniques for hierarchical data forecasting using processor-based Bayesian models and deep learning. One method includes accessing at least one data structure comprising data characterizing a performance of a plurality of hierarchical items, wherein the plurality of hierarchical items comprises one or more item families in an item family hierarchical level and at least a plurality of items in an item hierarchical level; applying at least portions of the data structure to at least one processor-based Bayesian-based model to obtain data characterizing an item family forecast for at least one of the item families and at least one first item-level forecast for one or more of the plurality of items; applying at least portions of the item family forecast to at least one processor-based deep learning model to obtain data characterizing at least one second item-level forecast for one or more of the plurality of items; and initiating one or more processing steps based at least in part on the at least one second item-level forecast.

Illustrative embodiments can provide significant advantages relative to conventional techniques. For example, technical problems related to such conventional techniques are mitigated in one or more embodiments by employing at least one Bayesian-based model to generate an item family forecast for at least one item family and at least one deep learning model to generate an item-level forecast for one or more items.

These and other illustrative embodiments described herein include, without limitation, methods, apparatus, systems, and computer program products comprising processor-readable storage media.

### BRIEF DESCRIPTION OF THE DRAWINGS

FIG. 1 illustrates an information processing system configured for hierarchical data forecasting using processor-based Bayesian models and deep learning in accordance with an illustrative embodiment;

FIG. 2 illustrates an example hierarchical item structure in accordance with an illustrative embodiment;

FIG. 3 illustrates an example of the hierarchical data forecasting platform of FIG. 1 in further detail in accordance with an illustrative embodiment;

FIG. 4 illustrates examples of the Bayesian-based models of FIG. 3 in further detail in accordance with an illustrative embodiment;

FIG. 5 illustrates exemplary pseudocode for a Bayesian item family-level forecasting process in accordance with an illustrative embodiment;

FIG. 6 illustrates exemplary pseudocode for a Bayesian item-level ratio forecasting process in accordance with an illustrative embodiment;

FIG. 7 illustrates exemplary pseudocode for a deep learning model weight determination process in accordance with an illustrative embodiment;

FIG. 8 illustrates exemplary pseudocode for a new item/item family performance data generation process in accordance with an illustrative embodiment;

FIG. 9 illustrates exemplary pseudocode for a growth-phase prediction process in accordance with an illustrative embodiment;

FIG. 10 illustrates an exemplary growth-phase for a given item in accordance with an illustrative embodiment;

FIG. 11 is a flow diagram illustrating an exemplary implementation of a process for hierarchical data forecasting using processor-based Bayesian models and deep learning in accordance with an illustrative embodiment;

FIG. 12 illustrates an exemplary processing platform that may be used to implement at least a portion of one or more embodiments of the disclosure comprising a cloud infrastructure; and

FIG. 13 illustrates another exemplary processing platform that may be used to implement at least a portion of one or more embodiments of the disclosure.

### DETAILED DESCRIPTION

Illustrative embodiments of the present disclosure will be described herein with reference to exemplary communication, storage and processing devices. It is to be appreciated, however, that the disclosure is not restricted to use with the particular illustrative configurations shown. One or more embodiments of the disclosure provide methods, apparatus and computer program products for hierarchical data forecasting using processor-based Bayesian models and deep learning.

One or more aspects of the disclosure recognize that it is often difficult to generate forecasts for items and/or item families (comprised of multiple items) when sufficient historical information for such items and/or item families is not available (e.g., when a new version of an old item becomes available). A flexible hierarchical data forecasting tool is provided that can leverage data associated with different levels of an item hierarchy (e.g., item families, in an upper item hierarchy level, comprised of multiple items, in a lower item hierarchy level) for accurate and reliable forecasts. A Bayesian methodology is used for item family-level forecasts where longer historical information (e.g., performance information, such as a sales history) is available, but the size of data, and thus learning, is limited. Deep learning techniques are used to learn from sizable individual item data, in terms of both rows and attributes, to forecast individual item-level sales. It can be shown that the disclosed item family-level forecast remains robust even in the presence of possible drift in individual item data and accuracies.

Thus, a hybrid forecasting framework is provided in some embodiments based on Bayesian and deep learning methodologies. The disclosed hybrid forecasting framework provides a reliable time-based forecast for a large item portfolio. To achieve high accuracy across a portfolio with frequent transitions, for example, the disclosed hybrid forecasting framework incorporates several key elements in some embodiments. For example, a deep learning model may be combined with a Bayesian hierarchical model into an ensemble architecture, leveraging the strengths of both approaches. The disclosed deep Bayesian model architecture takes advantage of the ability of the deep learning model to consume and leverage sizable item-level data, while also benefiting from the robustness of the Bayesian hierarchical model in high-level forecasting and reliability in considering item cannibalization (e.g., when one item takes sales from another item), for example, even when the number of active items varies significantly over time.

Supporting models are also provided to forecast new items, for example, during their growth and maturity phases. A deep learning cost function is provided to enhance the performance of the deep learning model. Additionally, the disclosed hybrid forecasting framework can utilize data across multiple hierarchy levels and adapt to frequently changing data based on, for example, business item launch plans and market disruptions, such as the Covid-19 pandemic. For example, the disclosed hybrid forecasting framework provides a cold start forecasting model, whereby item forecasts may be generated even when there is little or no historical performance information available (e.g., even when a one-to-one item transition from an old item to a new item does not exist).

A performance data generation supporting model may be provided in some embodiments to generate forecasts (e.g., sales forecasts) for new items with no historical information. The performance data generation supporting model generates a similarity score based on the attributes of each new item compared to existing items and then leverages the historical information of the most similar existing items to generate performance forecasts for the new item (e.g., when the new item is first introduced). The disclosed approach is flexible in considering multiple similar items in its forecasts, so such a one-to-one transition is not required. The results of the performance data generation supporting model can be applied to the main pipeline to forecast new items along with existing ones.

Another aspect of the disclosure provides a model to estimate a duration of a growth phase for new items. In the disclosed approach, a growth phase prediction supporting model is included that estimates an amount of time that a new item will be in a growth/ramp up phase until the performance of the new item reaches full capacity. The growth phase prediction supporting model, in some embodiments, leverages recent historical information (e.g., performance data, such as a sales history) of items during their first year of market introduction, for example, inventory data of their predecessor items, and their attributes to estimate the expected ramp up time. The result of the growth phase prediction supporting model can be applied to the main pipeline to adjust the forecasts of new items within their growth phase.

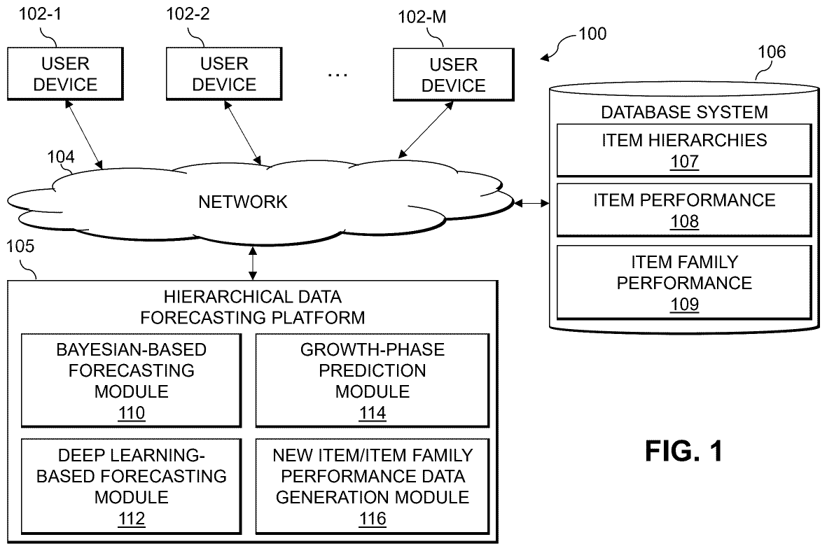

FIG. 1 shows a computer network (also referred to herein as an information processing system) 100 configured in accordance with an illustrative embodiment. The computer network 100 comprises a plurality of user devices 102-1, 102-2, . . . 102-M, collectively referred to herein as user devices 102. The user devices 102 are coupled to a network 104, where the network 104 in this embodiment is assumed to represent a sub-network or other related portion of the larger computer network 100. Accordingly, elements 100 and 104 are both referred to herein as examples of “networks,” but the latter is assumed to be a component of the former in the context of the FIG. 1 embodiment. Also coupled to network 104 is a hierarchical data forecasting platform 105 and a database system 106.

The user devices 102 may comprise, for example, devices such as mobile telephones, laptop computers, tablet computers, desktop computers or other types of computing devices. Such devices are examples of what are more generally referred to herein as “processing devices.” Some of these processing devices are also generally referred to herein as “computers.”

The user devices 102 in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

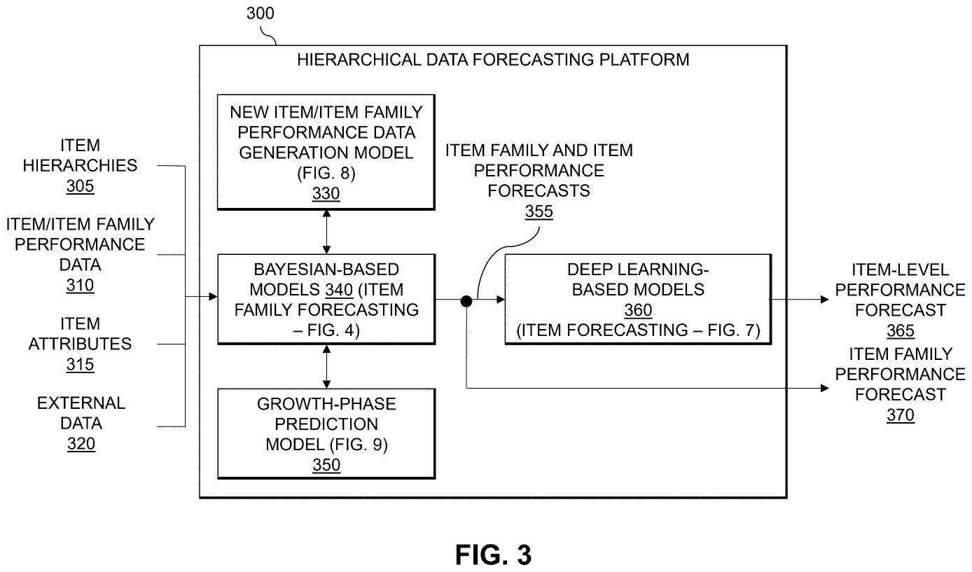

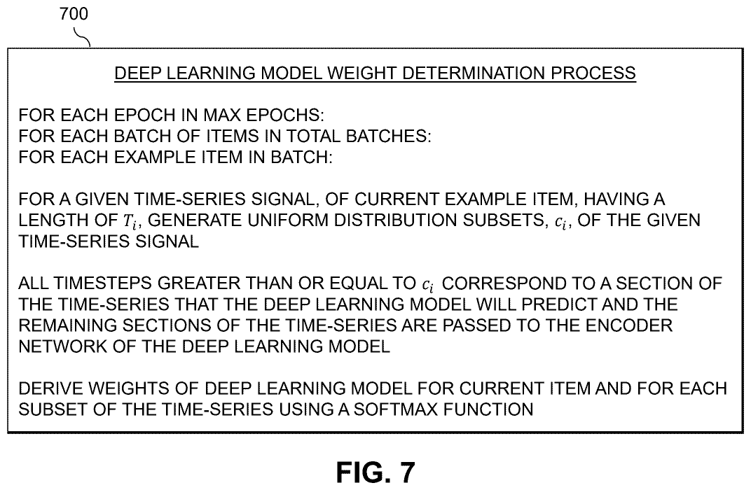

The hierarchical data forecasting platform 105 may comprise a Bayesian-based forecasting module 110, a deep learning-based forecasting module 112, a growth-phase prediction module 114 and a new item/item family performance data generation module 116. The Bayesian-based forecasting module 110, in some embodiments, may generate one or more item family and item performance forecasts, as discussed further below in conjunction with FIGS. 3 through 6, for example. In at least some embodiments, the deep learning-based forecasting module 112 may generate one or more item-level performance forecasts, as discussed further below in conjunction with FIGS. 3 and 7, for example.

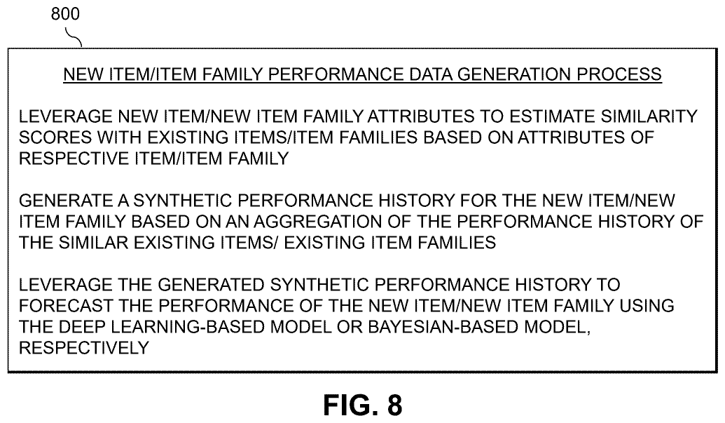

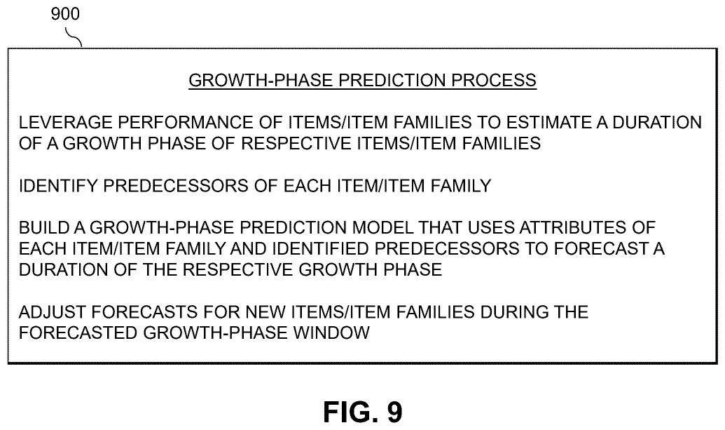

In one or more embodiments, the growth-phase prediction module 114 may determine an estimated duration of a growth phase for one or more items and/or item families, as discussed further below in conjunction with FIG. 9, for example. The new item/item family performance data generation module 116 may generate a synthetic performance history for one or more new items and/or new item families, as discussed further below in conjunction with FIG. 8, for example.

It is to be appreciated that this particular arrangement of elements 110, 112, 114 and/or 116 illustrated in the hierarchical data forecasting platform 105 of the FIG. 1 embodiment is presented by way of example only, and alternative arrangements can be used in other embodiments. For example, the functionality associated with the elements 110, 112, 114 and/or 116 in other embodiments can be combined into a single module, or separated across a larger number of modules. As another example, multiple distinct processors can be used to implement different ones of the elements 110, 112, 114 and/or 116 or portions thereof.

At least portions of elements 110, 112, 114 and/or 116 may be implemented at least in part in the form of software that is stored in memory and executed by a processor.

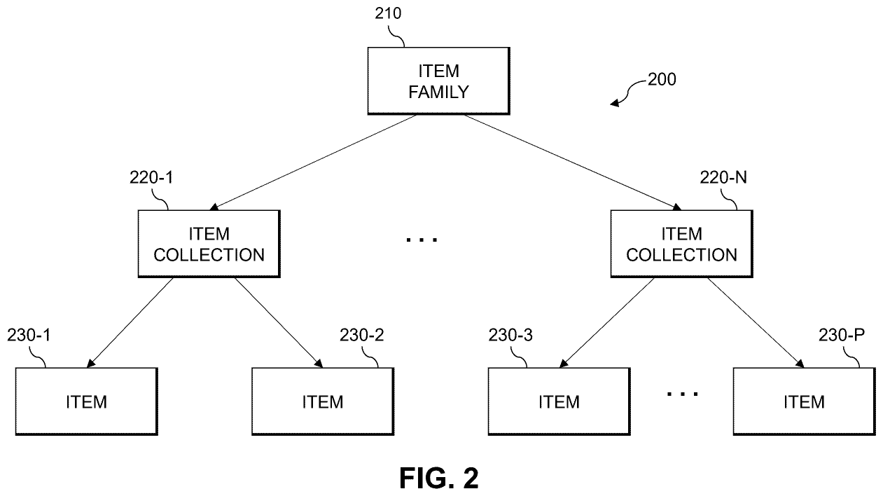

Additionally, the database system 106 may comprise one or more databases, such as an item hierarchies database 107 (e.g., comprising information characterizing a hierarchy of items, as discussed further below in conjunction with FIG. 2), an item performance database 108 (e.g., comprising information characterizing a performance of items), and an item family performance database 109 (e.g., comprising information characterizing a performance of item families). The databases 107, 108, 109 may be configured to store data, for example, in tables, in a known manner. While the databases 107, 108 and 109 are illustrated in FIG. 1 as comprising distinct databases, at least portions of the databases 107, 108, 109 may be implemented using a single database (e.g., different parts of a single database). Example databases 107, 108, 109, such as depicted in the present embodiment, can be implemented using one or more storage systems associated with the hierarchical data forecasting platform 105. Such storage systems can comprise any of a variety of different types of storage including network-attached storage (NAS), storage area networks (SANs), direct-attached storage (DAS) and distributed DAS, as well as combinations of these and other storage types, including software-defined storage.

Also associated with the hierarchical data forecasting platform 105 are one or more input-output devices, which illustratively comprise keyboards, displays or other types of input-output devices in any combination. Such input-output devices can be used, for example, to support one or more user interfaces to the hierarchical data forecasting platform 105, as well as to support communication between hierarchical data forecasting platform 105 and other related systems and devices not explicitly shown.

Additionally, the hierarchical data forecasting platform 105 in the FIG. 1 embodiment is assumed to be implemented using at least one processing device. Each such processing device generally comprises at least one processor and an associated memory, and implements one or more functional modules for controlling certain features of the hierarchical data forecasting platform 105.

More particularly, the hierarchical data forecasting platform 105 in this embodiment can comprise a processor coupled to a memory and a network interface.

The processor illustratively comprises a microprocessor, a microcontroller, an application-specific integrated circuit (ASIC), a field-programmable gate array (FPGA), a central processing unit (CPU), a graphical processing unit (GPU), a tensor processing unit (TPU), a video processing unit (VPU), a neural processing unit (NPU), a data processing unit (DPU), a System-On-Chip (SOC) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage drive, a storage array or an integrated circuit containing memory, as well as a wide variety of other types of computer program products. The term “article of manufacture” as used herein should be understood to exclude transitory, propagating signals. These and other references to “drives” herein are intended to refer generally to storage devices, including solid-state drives (SSDs), and should therefore not be viewed as limited in any way to particular storage media types.

The network interface allows the hierarchical data forecasting platform 105 to communicate over the network 104 with the user devices 102, and illustratively comprises one or more conventional transceivers.

It is to be understood that the particular set of elements shown in FIG. 1 for the hierarchical data forecasting platform 105 involving user devices 102 of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, one or more of the hierarchical data forecasting platform 105 and at least portions of the database system 106 can be on and/or part of the same processing platform.

FIG. 2 illustrates an example hierarchical item structure 200 in accordance with an illustrative embodiment. In the example of FIG. 2, three hierarchical item levels are shown. The number of hierarchical items in a given implementation of the disclosed hierarchical data forecasting platform, however, can be adjusted based on the number of hierarchical levels needed in a given implementation, as would be apparent to a person of ordinary skill in the art.

The exemplary hierarchical item structure 200 of FIG. 2 comprises an item family level 210 comprising one or more item families, an item collection level 220 comprising one or more item collections 220-1 through 220-N, and an individual item level 230 comprising one or more items 230-1 through 220-P.

For example, one item hierarchy may comprise a top level hierarchy comprising computing devices, a second level hierarchy comprising servers, desktop computers and laptops, for example, a third level hierarchy where, for example, the laptop computers comprise multiple models of laptops, and a lowest level hierarch where a given laptop model comprises different laptop configurations (e.g., unique characteristics, components and/or features) of the given laptop model.

One or more aspects of the disclosure recognize that at the top item family level 210 in the hierarchical item structure 200 of FIG. 2, each item family (and/or the items within a given item family) typically has a long history and significant performance information available for the respective item families. In addition, at the bottom individual item level 230, however, new items typically have little or no available history. Thus, in one or more embodiments, the disclosed hierarchical data forecasting techniques employ a Bayesian-based forecasting approach to generate item family-level forecasts for the top item family level 210, where a significant performance history is expected, and employ a different approach, based on deep learning techniques, deep techniques towards for the bottom individual item level 230 (e.g., leaf nodes) to generate item-level forecasts where little or no performance history is expected. In some embodiments, the item family-level forecasts are distributed among the underlying individual items of the bottom individual item level 230 (e.g., the leaf nodes) to generate the item-level forecasts. In other implementations, the underlying individual items of the bottom individual item level 230 (e.g., the leaf nodes) may comprise other types of items where quantities are monitored over time, such as power consumption, event attendance, as would be apparent to a person of ordinary skill in the art.

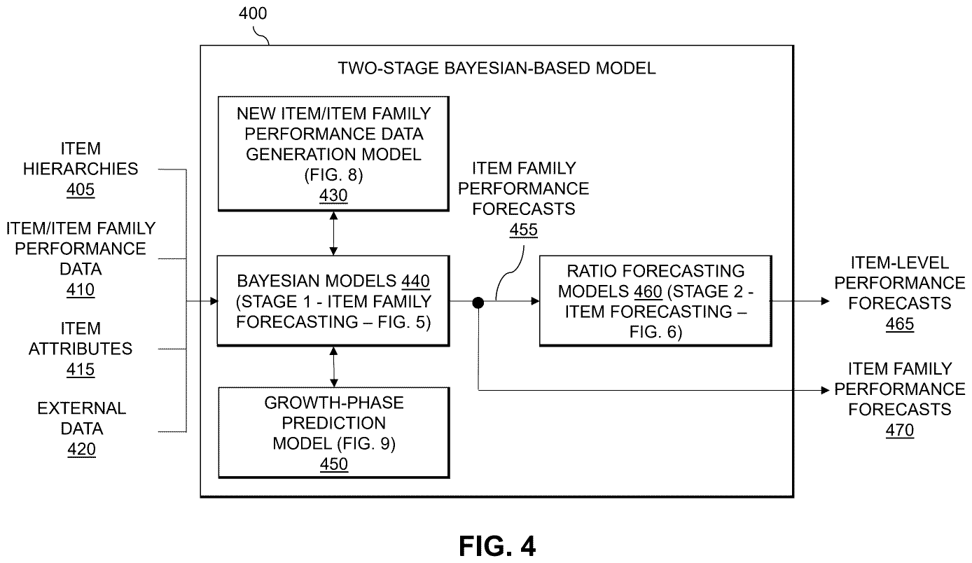

In this manner, the disclosed hierarchical data forecasting platform can consume data associated with different item hierarchy levels and leverage the appropriate data for each item level, as discussed further below in conjunction with FIGS. 4 through 7, for example (e.g., even when there is little or no performance data available at a given level). The disclosed hierarchical data forecasting approach can use the longer performance history available at a higher item hierarchy level (e.g., for an item family level) to infer a performance for one or more lower item hierarchy levels (e.g., for individual items within a given item family.

FIG. 3 illustrates an example of the hierarchical data forecasting platform 300 of FIG. 1 in further detail in accordance with an illustrative embodiment. In the example of FIG. 3, one or more Bayesian-based models 340 process item hierarchies 305, item/item family performance data 310 (e.g., sales history data), item attributes 315, and external data 320. The external data 320 may comprise holiday information, seasonality information and other external regressors that need to be accounted for (e.g., due to the Covid pandemic).

The one or more Bayesian-based models 340 generate one or more item family and item performance forecasts 355, as discussed further below in conjunction with FIG. 4. An item family performance forecast portion of the item family and item performance forecasts 355 may be provided, as an output, as item family performance forecast 370. The one or more Bayesian-based models 340 may also process one or more synthetic performance histories for new items and/or new item families, as generated, for example, by a new item/item family performance data generation model 330, as discussed further below in conjunction with FIG. 8, for example, as well as a predicted duration of a growth phase, as generated, for example, by a growth-phase prediction model 350, as discussed further below in conjunction with FIG. 9, for example.

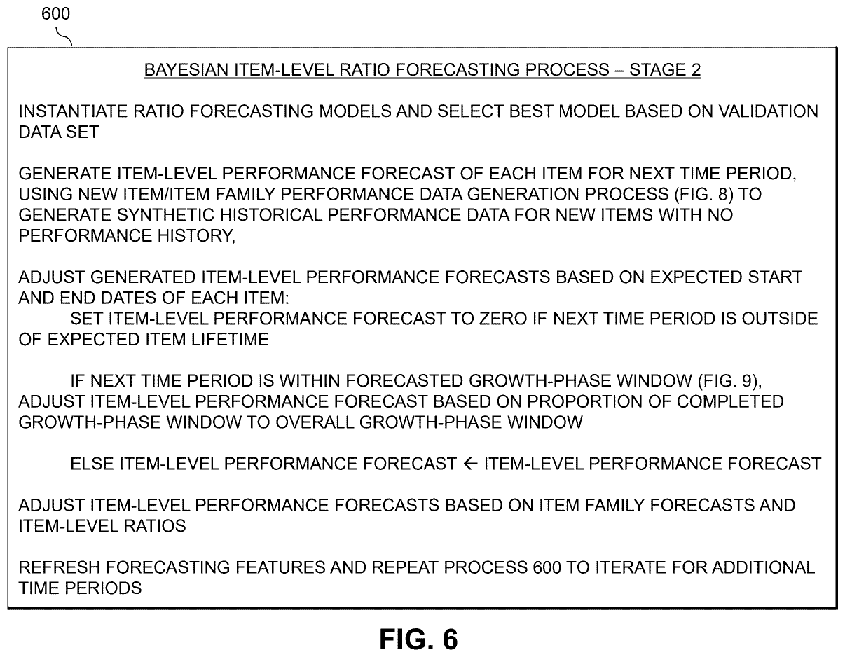

In addition, one or more deep learning-based models 360 process at least a portion of the one or more item family and item performance forecasts 355, from the Bayesian-based models 340, and generate one or more item-level performance forecasts 365, as discussed further below in conjunction with FIG. 7. In some embodiments, the item family performance forecasts 370 are distributed among the underlying individual items to generate the one or more item-level performance forecasts 365 using one or more item-level ratios, discussed further below in conjunction with FIG. 6.

In one or more embodiments, the deep learning-based models 360 of FIG. 3 may be implemented using a temporal fusion transformer (see, for example, B. Lim et al., Int'l J. of Forecasting, 2021, incorporated by reference herein in its entirety). In some embodiments, the deep learning-based models 360 process substantially the same input data as the Bayesian-based models 340, as well as the item family performance forecast generated by the Bayesian-based models 340.

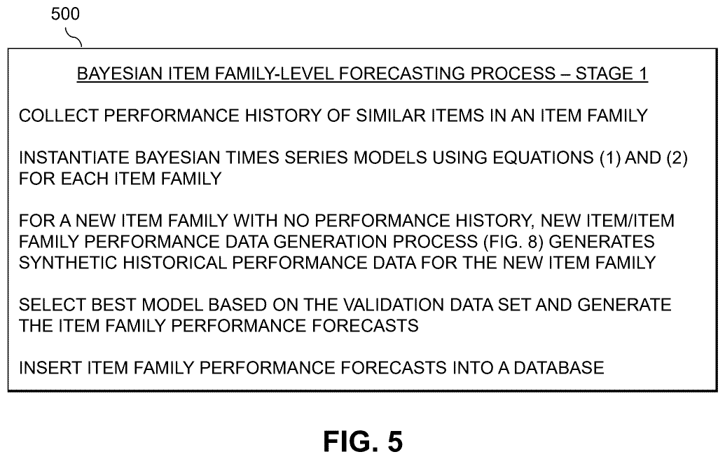

FIG. 4 illustrates examples of the Bayesian-based models 340 of FIG. 3 in further detail in accordance with an illustrative embodiment. In the example of FIG. 4, a two-stage Bayesian-based model 400 is shown. The two-stage Bayesian-based model 400 comprises one or more Bayesian models 440 (e.g., Bayesian additive models) that generate one or more item family performance forecasts 470 in a first stage, as discussed further below in conjunction with FIG. 5, and one or more ratio forecasting models 460 that generate one or more item-level performance forecasts 465 in a second stage, as discussed further below in conjunction with FIG. 6. As noted above, the item family performance forecasts 470 and the item-level performance forecasts 465 may be provided to the one or more deep learning-based models 360 of FIG. 3 for further processing.

As shown in FIG. 4, one or more Bayesian models 440 process item hierarchies 405, item/item family performance data 410 (e.g., sales history data), item attributes 415, and external data 420, in a similar manner as discussed above in conjunction with FIG. 3. The external data 420 may comprise holiday information, seasonality information and other external regressors that need to be accounted for (e.g., due to the Covid pandemic). The one or more Bayesian models 440 may also process one or more synthetic performance histories for new items and/or new item families, as generated, for example, by a new item/item family performance data generation model 430, as discussed further below in conjunction with FIG. 8, for example, as well as a predicted duration of a growth phase, as generated, for example, by a growth-phase prediction model 450, as discussed further below in conjunction with FIG. 9, for example.

The one or more ratio forecasting models 460 may implement a Bayesian item-level ratio forecasting process 600, as discussed further below in conjunction with FIG. 6, for example, to generate the one or more item-level performance forecasts 465 in a second stage.

FIG. 5 illustrates exemplary pseudocode for a Bayesian item family-level forecasting process 500 in accordance with an illustrative embodiment. The Bayesian item family-level forecasting process 500 may be implemented by the one or more Bayesian models 440 of FIG. 4, for example.

In the example of FIG. 5, a performance history is initially collected for similar items in an item family. One or more Bayesian times series models (e.g., Bayesian additive models) are instantiated (e.g., for each item family) using the equations (1) and (2):

$$y ( t ) = g ( t ) + h ( t ) + s ( t ) + X ( t ) β + e ( t ) , \qquad ( 1 )$$

where y(t) is a target variable for a family-level forecast, g(t) is a growth trend term, h(t) is a holiday effect term, s(t) is a seasonality term, X(t)β are the external regressor terms and e(t) is an error term.

For the growth terms, g(t), of equation (1), a logistic growth model may be expressed, as follows:

$$g ( t ) = \frac{C ( t )}{1 + {e}^{- k ( t - {t}_{0} )}} \qquad ( 2 )$$

where C(t) is a curves maximum value, k is a logistic growth rate, and to is a Sigmoid point/offset parameter.

The exemplary Bayesian additive models may consider, for example, weekly, monthly, and/or yearly non-linear seasonality of performance history (e.g., sales history), plus holidays and other relevant external signals for each item family.

In some embodiments, the curves maximum value C(t) term modifies the forecast based on the latest 6 to 12 months, for example, of performance history observed in each time series. This growth trend term does not exceed the maximum value observed over the last 6-12 months. As a result, the recent observations define the saturation level of the forecast. If the performance starts to increase, the C(t) term increases gradually and if the performance starts to go down, the model dynamically decreases the forecasts as the C(t) term decreases with new data. Also, a saturation floor based on the latest 6-12 months may be defined (e.g., which works in the same way to avoid any negative or unrealistically low values based on the recent market). This technique gives more weight to the observations of the last 6-12 months and tunes the forecasts to not be impacted too much by extremely high or low older observations in the far past.

The one or more Bayesian models 440 may be trained on overall market estimates, intended item start and end dates, relevant Internet search data, Covid intervention, holidays and/or discount data, for example. Several models may be created each with a subset of the input signals, and their performance can be compared over a validation set (e.g., a one-year validation set). The model with the best performance over the validation set may be selected (e.g., leveraging a subset of external signals that could enhance the model performance).

A Covid intervention signal may be defined, for example, as a pulse that started with the start of the Covid pandemic and decayed stepwise by the end of the year 2021. The Covid intervention signal is designed in some embodiments to decouple the impact of the Covid pandemic from the regular seasonality of performance data. Models measured the average impact of the Covid intervention on performance in each item family and takes the impact into account for future inference. The Covid intervention signal allows the models to leverage the performance data during the pandemic time despite different market dynamics, for example.

The Bayesian item family-level forecasting process 500 may also process one or more synthetic performance histories for new items and/or new item families that may have little or no performance history. The synthetic performance histories may be generated, for example, as discussed further below in conjunction with FIG. 8.

FIG. 6 illustrates exemplary pseudocode for a Bayesian item-level ratio forecasting process 600 in accordance with an illustrative embodiment. The Bayesian item-level ratio forecasting process 600 may be implemented by the one or more ratio forecasting models 460 of FIG. 4, for example. The Bayesian item-level ratio forecasting process 600 initially instantiates one or more ratio forecasting models and selects a best model based on a validation data set.

The Bayesian item-level ratio forecasting process 600 generates item-level performance forecasts for each item for a next time period. If a given item does not have a significant performance history, the Bayesian item-level ratio forecasting process 600 may employ one or more synthetic performance histories for such new items that may have little or no performance history. The synthetic performance histories may be generated, for example, as discussed further below in conjunction with FIG. 8.

The Bayesian item-level ratio forecasting process 600 may employ one or more ad-hoc functions leveraging the expected start and end dates for the life of each item. These functions control when a performance forecast should or should not be generated for an item. For example, sales may not be expected before an item gets launched or after its life cycle ends. Such an ad-hoc function may be applied before normalization in the example of FIG. 6 to avoid generating a non-zero forecast for an item out of its life span.

In addition, item-level performance forecasts may be adjusted, for example, if the time period being forecasted is within a forecasted growth-phase window (as discussed further below in conjunction with FIG. 9). The adjustment to such item-level performance forecasts may be based, for example, on a proportion of the completed growth-phase window relative to the overall predicted growth-phase window.

In the example of FIG. 6, individual item forecasts are generated by distributing item family forecasts, generated by the Bayesian item family-level forecasting process 500 of FIG. 5, among the appropriate items using ratio models. One normalization step may ensure that forecasts for individual items within a given item family add up to the item family level forecast. The exemplary normalization step may normalize or adjust item level forecasts using the item family forecasts, as follows:

$$Forecasts of {Item}_{i} ← \frac{Fore casts of {Item}_{i}}{{\sum }_{i = 1}^{n} F o r e casts of {Item}_{i}} \times Forecast of Item Family A , where {Item}_{1 to n} belong to Item Family A .$$

The forecasting features may be refreshed and an execution of the Bayesian item-level ratio forecasting process 600 of FIG. 6 may be repeated to iterate for additional time periods.

FIG. 7 illustrates exemplary pseudocode for a deep learning model weight determination process 700 in accordance with an illustrative embodiment. One challenge encountered when training a neural network using time series data for many different items is addressing the imbalanced target variable. Traditional solutions to overcoming imbalanced regression tend to employ cost-sensitive weights or data augmentation (e.g., downsampling or upsampling training records). The latter approach is scarce in the time-series forecasting domain. Many training procedures rely on cost-sensitive weights where sparse regions of the target variable get more importance (e.g., a higher weight) than dense regions of the target variable. Traditionally, these weights are derived once and do not change through the training procedure. The disclosed approach found that dynamic example-specific weights yielded the best performance. A given training example is assigned new target variable weights in some embodiments based on the target variable distribution that is sampled/generated at a given epoch of the training loop.

In the example of FIG. 7, each epoch corresponds to another iteration that changes model parameters within a batch of items. Each item is referred to as an example in the deep learning model weight determination process 700 of FIG. 7. The weights, wᵢ, of the deep learning model are derived in the example of FIG. 7 for the current item being processed and for each subset of the time-series for the current item being processed using a softmax function, expressed as follows:

$${w}_{i} = \frac{exp ( {y}_{i {c}_{i} : {T}_{i}} )}{sum ( exp ( {y}_{i {s}_{i} : {T}_{i}} ) )} \cdot {s}_{i}$$

where wᵢ is the determined weight, yᵢ is a target variable for what is being forecast, sᵢ is a sample cut from a uniform distribution subset of the given time-series signal, and Tᵢ is the length of the full time-series signal for the current item.

In the example of FIG. 7, the deep learning model learns to generate accurate forecasts for the minority section of the target variable, using the derived weights in the loss function. For a given example, more importance or weight may be allocated to higher values of yᵢ. Furthermore, this weight is relative to this section or portion of the time-series. The weights are derived in the training loop and are dynamic across different training examples and sections of the sampled time-series. As noted above, most traditional approaches calculate these weights once, before training, and the weight for a given yᵢ is the same across all training examples. Empirically, it can be shown that the disclosed approach of FIG. 7 performed better than traditional approaches.

FIG. 8 illustrates exemplary pseudocode for a new item/item family performance data generation process 800 in accordance with an illustrative embodiment. One or more aspects of the disclosure recognize that it is often difficult to generate forecasts for items and/or item families when historical information for such items and/or item families is limited or not available (e.g., when a new version of an old item becomes available).

In the example of FIG. 8, the most similar existing items to a new item are identified and the historical performance information of the most similar existing items (e.g., a sales history) is leveraged to predict the performance with respect to the new item (e.g., to forecast performance, such as sales, of the new item). For example, if the market transitions from five lines of items to two lines of items, the new item/item family performance data generation process 800 can learn non-one-to-one mappings during the transition based on similarity scores.

In this manner, item forecasts may be generated even with there is little or no historical performance information (e.g., a sales history) available (e.g., even when a one-to-one item transition does not exist). The new item/item family performance data generation process 800 can be considered a performance data generation supporting model that allows forecasts (e.g., sales forecasts) to be generated for new items with little, or no, historical performance information. The performance data generation supporting model generates a similarity score based on the attributes of each new item (or item family) compared to existing items (or item families) and then leverages the historical performance information of the most similar existing items to generate performance forecasts for the new item (e.g., when the new item goes live). The disclosed synthetic performance history generation approach is flexible in considering multiple similar items in its forecasts, so a one-to-one transition from an old item to a new item is not required. The results of the performance data generation supporting model can be applied to the main pipeline to forecast new items along with existing ones, as discussed above in conjunction with FIG. 3, for example.

FIG. 9 illustrates exemplary pseudocode for a growth-phase prediction process 900 in accordance with an illustrative embodiment. In the example of FIG. 9, the growth-phase prediction process 900 estimates the duration that a new item is expected to remain in a growth phase and then readjusts the forecasts accordingly. This growth phase can vary widely depending on the item lines and the industry. Individual items are often short-lived and do not have a long enough history to generate a reliable long-term forecast. However, a longer item family-level history is often available. Thus, one or more aspects of the disclosure recognize that forecasting can be separated into two stages in some embodiments. Forecasts are initially generated at the item family-level, for example, by the one or more Bayesian-based models 340. Then, the one or more deep learning-based models 360 distribute the item family-level forecasts among the underlying individual items.

The growth-phase prediction process 900 determines an expected duration of a growth phase for new items (e.g., until the performance of the new item reaches full capacity). The growth-phase prediction process 900, in some embodiments, leverages recent historical information (e.g., performance data, such as a sales history) of items during their first year of market introduction, for example, as well as inventory data of their predecessor items, and their attributes, to estimate the expected duration of the growth phase. As noted above, the expected duration of the growth phase for new items can be applied to the main pipeline to adjust the forecasts of new items within their growth phase.

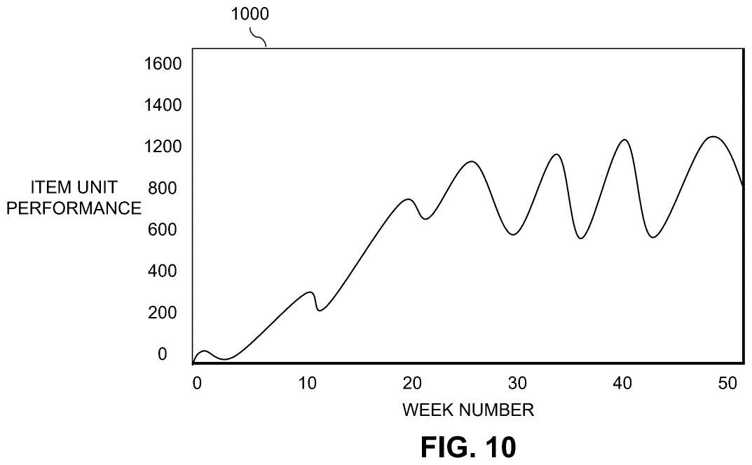

FIG. 10 illustrates an exemplary growth-phase 1000 for a given item in accordance with an illustrative embodiment. In the example of FIG. 10, the growth-phase 1000 illustrates an item unit performance (e.g., number of items sold per week) for the initial 50 weeks that the given item is available. Generally, the growth-phase 1000 increases for the first 27 weeks (e.g., the duration of the growth phase) and then begins to oscillate around a baseline value of approximately 800 units per week.

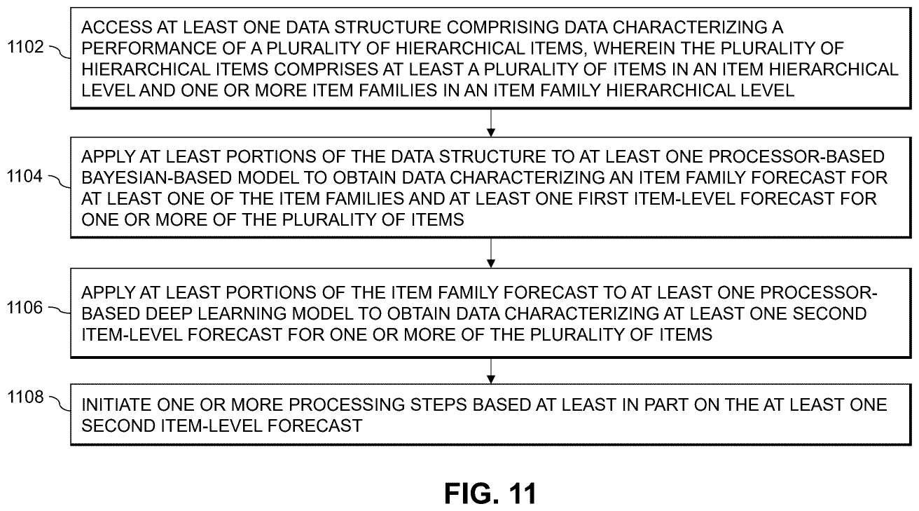

FIG. 11 is a flow diagram illustrating an exemplary implementation of a process for hierarchical data forecasting using processor-based Bayesian models and deep learning in accordance with an illustrative embodiment. In the example of FIG. 11, at least one data structure is initially accessed in step 1102. The at least one data structure comprises data characterizing a performance of a plurality of hierarchical items, wherein the plurality of hierarchical items comprises one or more item families in an item family hierarchical level and at least a plurality of items in an item hierarchical level.

At least portions of the data structure are applied in step 1104 to at least one processor-based Bayesian-based model to obtain data characterizing an item family forecast for at least one of the item families and at least one first item-level forecast for one or more of the plurality of items. At least portions of the item family forecast are applied in step 1106 to at least one processor-based deep learning model to obtain data characterizing at least one second item-level forecast for one or more of the plurality of items.

One or more processing steps are initiated in step 1108 based at least in part on the at least one second item-level forecast.

It should be noted that the term “data structure” as used herein is intended to be broadly construed. A data structure, such as any single one of or combination of the data structures referred to above, may provide a portion of a larger data structure, or any one of or combination of the data structures may be combinations of multiple smaller data structures. Therefore, the data structures referred to above may be different parts of a same overall data structure, or one or more of the data structures could be made up of multiple smaller data structures. The data structures may include tables, vectors, embeddings, or various other data structures. In some embodiments, the data structures are specifically formatted or generated such that they are suitable for use as at least one of an input to and an output from an ML model. It should further be appreciated that “generating” a data structure may encompass, for example, populating an existing or previously-created data structure with one or more data items and that “accessing” a data structure may encompass, for example, obtaining a portion (e.g., one or more data items) of one or more data structures by means of a query, select or filter operation, for example.

In at least one embodiment, the at least one processor-based Bayesian-based model may comprise at least one Bayesian model and at least one ratio forecasting model, and wherein the at least one ratio forecasting model processes the item family forecast generated by the at least one Bayesian model using an item-level ratio for the items in the item family to generate the at least one first item-level forecast for the one or more items. The at least one Bayesian model and/or or the at least one ratio forecasting model may process synthetic performance data for (a) at least one new item and/or (b) at least one new item family, respectively. The synthetic performance data for the (a) the at least one new item and/or (b) the at least one new item family may be generated by evaluating a similarity of at least one attribute of: (a) the at least one new item or (b) the at least one new item family, respectively, with respect to the at least one attribute of: a plurality of existing items or a plurality of existing item families, respectively, and the synthetic performance data may be generated based at least in part on a performance of similar items or similar existing item families, respectively, that satisfy one or more designated similarity criteria.

In one or more embodiments, a given one of the at least one first item-level forecast for the one or more items may be automatically set to zero outside of an expected lifetime of the given item. A given one of the at least one first item-level forecast for the one or more items may be automatically adjusted based at least in part on an expected duration of a growth-phase of the given item. One or more weights of the at least one processor-based deep learning model may comprise item-specific weights that are determined for each of one or more of the items.

The particular processing operations and other network functionality described in conjunction with FIGS. 3 through 9 and 11, for example, are presented by way of illustrative example only, and should not be construed as limiting the scope of the disclosure in any way. Alternative embodiments can use other types of processing operations for hierarchical data forecasting using processor-based Bayesian models and deep learning. For example, the ordering of the process steps may be varied in other embodiments, or certain steps may be performed concurrently with one another rather than serially. In one aspect, the process can skip one or more of the steps. In other aspects, one or more of the steps are performed simultaneously. In some aspects, additional steps can be performed.

One or more embodiments of the disclosure provide improved methods, apparatus and computer program products for hierarchical data forecasting using processor-based Bayesian models and deep learning. The foregoing applications and associated embodiments should be considered as illustrative only, and numerous other embodiments can be configured using the techniques disclosed herein, in a wide variety of different applications.

It should also be understood that the disclosed techniques for hierarchical data forecasting using processor-based Bayesian models and deep learning, as described herein, can be implemented at least in part in the form of one or more software programs stored in memory and executed by a processor of a processing device such as a computer. As mentioned previously, a memory or other storage device having such program code embodied therein is an example of what is more generally referred to herein as a “computer program product.”

The disclosed techniques for hierarchical data forecasting using processor-based Bayesian models and deep learning may be implemented using one or more processing platforms. One or more of the processing modules or other components may therefore each run on a computer, storage device or other processing platform element. A given such element may be viewed as an example of what is more generally referred to herein as a “processing device.”

As noted above, illustrative embodiments disclosed herein can provide a number of significant advantages relative to conventional arrangements. It is to be appreciated that the particular advantages described above and elsewhere herein are associated with particular illustrative embodiments and need not be present in other embodiments. Also, the particular types of information processing system features and functionality as illustrated and described herein are exemplary only, and numerous other arrangements may be used in other embodiments.

In these and other embodiments, compute and/or storage services can be offered to cloud infrastructure tenants or other system users as a Platform-as-a-Service (PaaS) model, an Infrastructure-as-a-Service (IaaS) model, a Storage-as-a-Service (STaaS) model and/or a Function-as-a-Service (FaaS) model, although numerous alternative arrangements are possible.

Some illustrative embodiments of a processing platform that may be used to implement at least a portion of an information processing system comprise cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components such as a cloud-based hierarchical data forecasting engine, or portions thereof, are illustratively implemented for use by tenants of such a multi-tenant environment.

Cloud infrastructure as disclosed herein can include cloud-based systems. Virtual machines provided in such systems can be used to implement at least portions of a cloud-based hierarchical data forecasting platform in illustrative embodiments. The cloud-based systems can include object stores.

In some embodiments, the cloud infrastructure additionally or alternatively comprises a plurality of containers implemented using container host devices. For example, a given container of cloud infrastructure illustratively comprises a Docker container or other type of Linux Container (LXC). The containers may run on virtual machines in a multi-tenant environment, although other arrangements are possible. The containers may be utilized to implement a variety of different types of functionality within the storage devices. For example, containers can be used to implement respective processing devices providing compute services of a cloud-based system. Again, containers may be used in combination with other virtualization infrastructure such as virtual machines implemented using a hypervisor.

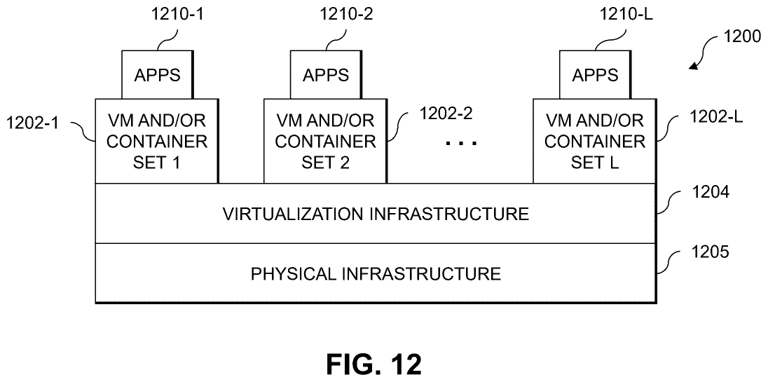

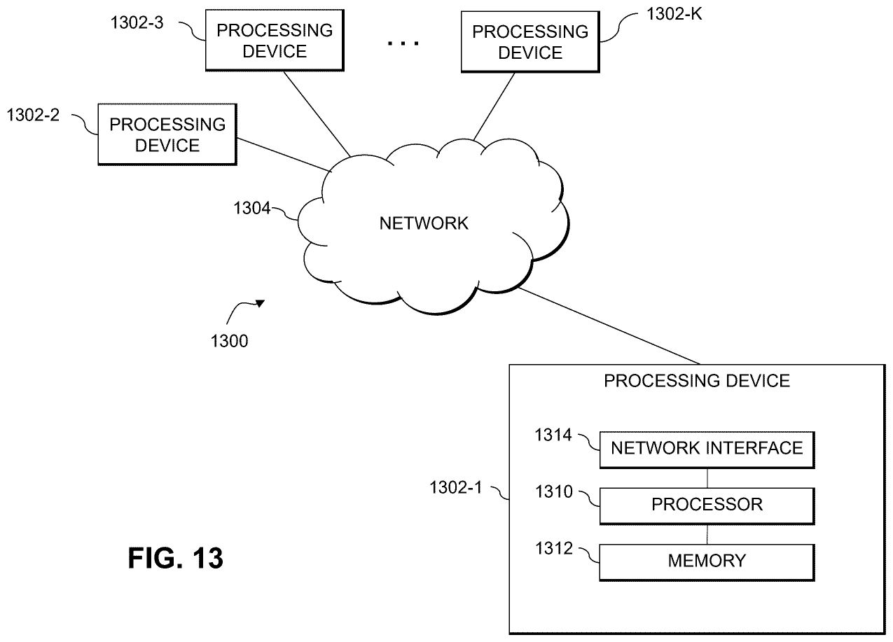

Illustrative embodiments of processing platforms will now be described in greater detail with reference to FIGS. 12 and 13. These platforms may also be used to implement at least portions of other information processing systems in other embodiments.

FIG. 12 shows an example processing platform comprising cloud infrastructure 1200. The cloud infrastructure 1200 comprises a combination of physical and virtual processing resources that may be utilized to implement at least a portion of the information processing system 100. The cloud infrastructure 1200 comprises multiple virtual machines (VMs) and/or container sets 1202-1, 1202-2, . . . 1202-L implemented using virtualization infrastructure 1204. The virtualization infrastructure 1204 runs on physical infrastructure 1205, and illustratively comprises one or more hypervisors and/or operating system level virtualization infrastructure. The operating system level virtualization infrastructure illustratively comprises kernel control groups of a Linux operating system or other type of operating system.

The cloud infrastructure 1200 further comprises sets of applications 1210-1, 1210-2, . . . 1210-L running on respective ones of the VMs/container sets 1202-1, 1202-2, . . . 1202-L under the control of the virtualization infrastructure 1204. The VMs/container sets 1202 may comprise respective VMs, respective sets of one or more containers, or respective sets of one or more containers running in VMs.

In some implementations of the FIG. 12 embodiment, the VMs/container sets 1202 comprise respective VMs implemented using virtualization infrastructure 1204 that comprises at least one hypervisor. Such implementations can provide chat assistant adaptation functionality of the type described above for one or more processes running on a given one of the VMs. For example, each of the VMs can implement control logic for hierarchical data forecasting and associated functionality for automated processing of such hierarchical data item forecasts.

An example of a hypervisor platform that may be used to implement a hypervisor within the virtualization infrastructure 1204 is a compute virtualization platform which may have an associated virtual infrastructure management system such as server management software. The underlying physical machines may comprise one or more distributed processing platforms that include one or more storage systems.

In other implementations of the FIG. 12 embodiment, the VMs/container sets 1202 comprise respective containers implemented using virtualization infrastructure 1204 that provides operating system level virtualization functionality, such as support for Docker containers running on bare metal hosts, or Docker containers running on VMs. The containers are illustratively implemented using respective kernel control groups of the operating system. Such implementations can provide chat assistant adaptation functionality of the type described above for one or more processes running on different ones of the containers. For example, a container host device supporting multiple containers of one or more container sets can implement one or more instances of control logic for hierarchical data forecasting and associated functionality for automated processing of such hierarchical data item forecasts.

As is apparent from the above, one or more of the processing modules or other components of system 100 may each run on a computer, server, storage device or other processing platform element. A given such element may be viewed as an example of what is more generally referred to herein as a “processing device.” The cloud infrastructure 1200 shown in FIG. 12 may represent at least a portion of one processing platform. Another example of such a processing platform is processing platform 1300 shown in FIG. 13.

The processing platform 1300 in this embodiment comprises at least a portion of the given system and includes a plurality of processing devices, denoted 1302-1, 1302-2, 1302-3, . . . 1302-K, which communicate with one another over a network 1304. The network 1304 may comprise any type of network, such as a WAN, a LAN, a satellite network, a telephone or cable network, a cellular network, a wireless network such as WiFi or WiMAX, or various portions or combinations of these and other types of networks.

The processing device 1302-1 in the processing platform 1300 comprises a processor 1310 coupled to a memory 1312. The processor 1310 may comprise a microprocessor, a microcontroller, an ASIC, an FPGA, a CPU, a GPU, a TPU, a VPU, an NPU, a DPU, an SOC or other type of processing circuitry, as well as portions or combinations of such circuitry elements, and the memory 1312, which may be viewed as an example of a “processor-readable storage media” storing executable program code of one or more software programs.

Articles of manufacture comprising such processor-readable storage media are considered illustrative embodiments. A given such article of manufacture may comprise, for example, a storage array, a storage drive or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1302-1 is network interface circuitry 1314, which is used to interface the processing device with the network 1304 and other system components, and may comprise conventional transceivers.

The other processing devices 1302 of the processing platform 1300 are assumed to be configured in a manner similar to that shown for processing device 1302-1 in the figure.

Again, the particular processing platform 1300 shown in the figure is presented by way of example only, and the given system may include additional or alternative processing platforms, as well as numerous distinct processing platforms in any combination, with each such platform comprising one or more computers, storage devices or other processing devices.

Multiple elements of an information processing system may be collectively implemented on a common processing platform of the type shown in FIG. 12 or 13, or each such element may be implemented on a separate processing platform.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage devices or other components are possible in the information processing system. Such components can communicate with other elements of the information processing system over any type of network or other communication media.

As indicated previously, components of an information processing system as disclosed herein can be implemented at least in part in the form of one or more software programs stored in memory and executed by a processor of a processing device. For example, at least portions of the functionality shown in one or more of the figures are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A method, comprising:
accessing at least one data structure comprising data characterizing a performance of a plurality of hierarchical items, wherein the plurality of hierarchical items comprises one or more item families in an item family hierarchical level and at least a plurality of items in an item hierarchical level;
applying at least portions of the data structure to at least one processor-based Bayesian-based model to obtain data characterizing an item family forecast for at least one of the item families and at least one first item-level forecast for one or more of the plurality of items;
applying at least portions of the item family forecast to at least one processor-based deep learning model to obtain data characterizing at least one second item-level forecast for one or more of the plurality of items; and
initiating one or more processing steps based at least in part on the at least one second item-level forecast;
wherein the method is performed by at least one processing device comprising a processor coupled to a memory.

2. The method of claim 1, wherein the at least one processor-based Bayesian-based model comprises at least one Bayesian model and at least one ratio forecasting model, and wherein the at least one ratio forecasting model processes the item family forecast generated by the at least one Bayesian model using an item-level ratio for one or more items in a given item family to generate the at least one first item-level forecast for the one or more items.

3. The method of claim 2, wherein (i) the at least one Bayesian model or (ii) the at least one ratio forecasting model processes synthetic performance data for (a) at least one new item or (b) at least one new item family, respectively.

4. The method of claim 3, wherein the synthetic performance data for the (a) the at least one new item or (b) the at least one new item family is generated by evaluating a similarity of at least one attribute of: (a) the at least one new item or (b) the at least one new item family, respectively, with respect to the at least one attribute of: a plurality of existing items or a plurality of existing item families, respectively, and generating the synthetic performance data based on a performance of similar items or similar existing item families, respectively, that satisfy one or more designated similarity criteria.

5. The method of claim 1, wherein a given one of the at least one first item-level forecast for the one or more items is automatically set to zero outside of an expected lifetime of the given item.

6. The method of claim 1, wherein a given one of the at least one first item-level forecast for the one or more items is automatically adjusted based at least in part on an expected duration of a growth-phase of the given item.

7. The method of claim 1, wherein one or more weights of the at least one processor-based deep learning model comprise item-specific weights that are determined for each of one or more of the items.

8. The method of claim 1, wherein the one or more processing steps comprise at least one of: generating a notification for approval of the at least one second item-level forecast, publishing the at least one second item-level forecast and causing an action to be performed in another system using the at least one second item-level forecast.

9. An apparatus comprising:
at least one processing device comprising a processor coupled to a memory;
the at least one processing device being configured to implement the following steps:
accessing at least one data structure comprising data characterizing a performance of a plurality of hierarchical items, wherein the plurality of hierarchical items comprises one or more item families in an item family hierarchical level and at least a plurality of items in an item hierarchical level;
applying at least portions of the data structure to at least one processor-based Bayesian-based model to obtain data characterizing an item family forecast for at least one of the item families and at least one first item-level forecast for one or more of the plurality of items;
applying at least portions of the item family forecast to at least one processor-based deep learning model to obtain data characterizing at least one second item-level forecast for one or more of the plurality of items; and
initiating one or more processing steps based at least in part on the at least one second item-level forecast.

10. The apparatus of claim 9, wherein the at least one processor-based Bayesian-based model comprises at least one Bayesian model and at least one ratio forecasting model, and wherein the at least one ratio forecasting model processes the item family forecast generated by the at least one Bayesian model using an item-level ratio for one or more items in a given item family to generate the at least one first item-level forecast for the one or more items.

11. The apparatus of claim 10, wherein (i) the at least one Bayesian model or (ii) the at least one ratio forecasting model processes synthetic performance data for (a) at least one new item or (b) at least one new item family, respectively, and wherein the synthetic performance data for the (a) the at least one new item or (b) the at least one new item family is generated by evaluating a similarity of at least one attribute of: (a) the at least one new item or (b) the at least one new item family, respectively, with respect to the at least one attribute of: a plurality of existing items or a plurality of existing item families, respectively, and generating the synthetic performance data based on a performance of similar items or similar existing item families, respectively, that satisfy one or more designated similarity criteria.

12. The apparatus of claim 9, wherein a given one of the at least one first item-level forecast for the one or more items is automatically set to zero outside of an expected lifetime of the given item.

13. The apparatus of claim 9, wherein a given one of the at least one first item-level forecast for the one or more items is automatically adjusted based at least in part on an expected duration of a growth-phase of the given item.

14. The apparatus of claim 9, wherein one or more weights of the at least one processor-based deep learning model comprise item-specific weights that are determined for each of one or more of the items.

15. A non-transitory processor-readable storage medium having stored therein program code of one or more software programs, wherein the program code when executed by at least one processing device causes the at least one processing device to perform the following steps:
accessing at least one data structure comprising data characterizing a performance of a plurality of hierarchical items, wherein the plurality of hierarchical items comprises one or more item families in an item family hierarchical level and at least a plurality of items in an item hierarchical level;
applying at least portions of the data structure to at least one processor-based Bayesian-based model to obtain data characterizing an item family forecast for at least one of the item families and at least one first item-level forecast for one or more of the plurality of items;
applying at least portions of the item family forecast to at least one processor-based deep learning model to obtain data characterizing at least one second item-level forecast for one or more of the plurality of items; and
initiating one or more processing steps based at least in part on the at least one second item-level forecast.

16. The non-transitory processor-readable storage medium of claim 15, wherein the at least one processor-based Bayesian-based model comprises at least one Bayesian model and at least one ratio forecasting model, and wherein the at least one ratio forecasting model processes the item family forecast generated by the at least one Bayesian model using an item-level ratio for one or more items in a given item family to generate the at least one first item-level forecast for the one or more items.

17. The non-transitory processor-readable storage medium of claim 16, wherein (i) the at least one Bayesian model or (ii) the at least one ratio forecasting model processes synthetic performance data for (a) at least one new item or (b) at least one new item family, respectively, and wherein the synthetic performance data for the (a) the at least one new item or (b) the at least one new item family is generated by evaluating a similarity of at least one attribute of: (a) the at least one new item or (b) the at least one new item family, respectively, with respect to the at least one attribute of: a plurality of existing items or a plurality of existing item families, respectively, and generating the synthetic performance data based on a performance of similar items or similar existing item families, respectively, that satisfy one or more designated similarity criteria.

18. The non-transitory processor-readable storage medium of claim 15, wherein a given one of the at least one first item-level forecast for the one or more items is automatically set to zero outside of an expected lifetime of the given item.

19. The non-transitory processor-readable storage medium of claim 15, wherein a given one of the at least one first item-level forecast for the one or more items is automatically adjusted based at least in part on an expected duration of a growth-phase of the given item.

20. The non-transitory processor-readable storage medium of claim 15, wherein one or more weights of the at least one processor-based deep learning model comprise item-specific weights that are determined for each of one or more of the items.
